(19) United States
(12) Patent Application Publication
(10) Pub. No.: US 2018/0305258 A1
(43) Pub. Date: Oct. 25, 2018

(54) SURFACTANT COMPOSITION

(71) Applicants: CSR BUILDING PRODUCTS LIMITED, North Ryde, New South Wales (AU); STEPAN COMPANY, Northfield, IL (US)

(72) Inventors: Greg Neil, St. Clair, New South Wales (AU); Dylan Riessen, Glenwood, New South Wales (AU); Brian Mirous, Northfield, IL (US)

(21) Appl. No.: 15/767,750

(22) PCT Filed: Oct. 14, 2016
(86) PCT No.: PCT/AU2016/050968

§ 371 Date: Apr. 12, 2018

(30) Foreign Application Priority Data
Oct. 14, 2015 (AU) 2015904191

(51) Int. Cl. C04B 24/16; C04B 40/00; C04B 38/10; C04B 28/14; C11D 1/37; B32B 13/04; B28B 19/00

(52) U.S. Cl. CPC C04B 24/16; C04B 40/0039; C04B 38/106; C04B 2103/40; C11D 1/37; B32B 13/04; B28B 19/0015; C04B 28/14

(57) ABSTRACT

Disclosed is a surfactant composition and its use in the production of a gypsum product. Also disclosed is a method of producing gypsum plasterboard, as well as gypsum plasterboard that is formed from foamed slurry comprising the surfactant composition. The surfactant composition comprises from 60 to 99 wt. % by total surfactant weight of an alkyl sulphate component having the structure: R¹—OSO₃⁻⁺M¹, in which R¹ is an alkyl having from 9 to 11 carbon atoms and M¹ is a cation. The surfactant composition also comprises from 1 to 40 wt. % by total surfactant weight of an alkyl ether sulphate component having the structure: R²—(OCH₂CH₂)_{y}OSO₃⁻⁺M², in which R² is an alkyl having from 8 to 10 carbon atoms, y has an average value of 0.1 to 5 and M² is a cation.

### TECHNICAL FIELD

A surfactant composition is disclosed. The surfactant composition may find particular application in the manufacture of a gypsum product, such as gypsum plasterboard. A plasterboard produced using the surfactant composition is also disclosed.

### BACKGROUND

Gypsum, calcium sulphate dihydrate (CaSO₄.2H₂O), is a naturally occurring mineral that has been used in the manufacture of products for the building and construction industries, amongst others, for decades. Natural gypsum mined from various sources can have different properties and, more recently, synthetic gypsum has also been produced which can have different properties, again, to natural gypsum. In order to be used in gypsum products, such as plasterboard, gypsum is usually calcined to form calcium sulphate hemihydrate (CaSO₄-% H₂O), also known as stucco, to remove the majority of the water. When the stucco is rehydrated to gypsum, the gypsum sets hard. There are various techniques available for calcining gypsum, each with different processing conditions, with the properties and structure of the resulting stucco being dependent on processing conditions such as methodology, particle size, temperature, pressure and rapidity. Known calcining methods include kettle processes (such as batch kettle, continuous kettle, submerged combustion kettle, and conical kettle), kiln processes (such as rotary kiln and conveyor kiln), flash calcination, impact mill calcination, ring ball calciner, the Calcidyne™ process, etc. Some calcination methods require the gypsum to be ground prior to calcination, others are ground subsequent to calcination, and others are ground simultaneous to calcination.

When the stucco is being rehydrated, it is rehydrated with excess water to form a gypsum slurry. The calcination technique used to prepare the stucco can affect various properties including the amount of water required to achieve appropriate fluidity of the slurry, rate of acceleration (setting), etc. When forming the slurry, other additives are usually mixed into the slurry, depending on the properties required of the final gypsum product. Such additives can include foam, accelerators, retarders, water reducing agents, stiffening agents, binding agents, fibre reinforcements, waterproofing agents, etc.

Foams are used to form voids in the set gypsum, with the voids assisting in reducing the weight of any resulting product. The use of one or more surfactants to generate an aqueous foam, which is then incorporated into a gypsum slurry, is known. In the preparation of plasterboard, for example, the foamed gypsum slurry is deposited onto a moving cover sheet and a second cover sheet is placed on top of the slurry. The slurry sets or hardens with voids, formed by the aqueous foam, in the core.

Over time, the types of surfactants used in the preparation of gypsum products has changed, as understanding of their effect on the resulting gypsum product has evolved. For example, up until the late 1980's, conventional wisdom was to use surfactants that resulted in a distribution of small voids, such as disclosed in U.S. Pat. No. 4,156,615 or U.S. Pat. No. 4,618,370. In the late 1980's, U.S. Pat. No. 5,085,929 suggested that the use of larger voids in the core, with relatively denser layers at the paper interface, could result in lighter, stronger gypsum board.

Foaming agents comprising blends of a stable component, such as alkyl ether sulphates, and an unstable component, such as alkyl sulphates, are disclosed in, for example, U.S. Pat. No. 5,240,639, U.S. Pat. No. 5,466,393, U.S. Pat. No. 5,643,510 and U.S. Pat. No. 5,714,001. By altering the ratio of stable and unstable soaps, the resulting void structure can be controlled. Whilst these documents broadly disclose alkyl sulphates having the structure R OSO₃-M+, where R is an alkyl group containing 2 to 20 carbon atoms and M is a cation, and alkyl ether sulphates having the structure CH₃(CH₂)ₓCH₂(OCH₂CH₂)_{y} OSO₃-M+, where x ranges from 2 to 20, y ranges from 0 to 10 and M is a cation, only a narrow subset of these formulations have been exemplified in the prior art.

A reference herein to the prior art does not constitute an admission that the art forms part of the common general knowledge of a person of skill in the art, and is not intended to limit the scope of the composition, method and gypsum product disclosed herein.

### SUMMARY

A surfactant composition is disclosed herein. The surfactant composition comprises from 60 to 99 wt. % by total surfactant weight of an alkyl sulphate component, and from 1 to 40 wt. % by total surfactant weight of an alkyl ether sulphate component. The alkyl sulphate component has the general structure R¹—OSO₃⁻⁺M¹ in which R¹ is an alkyl having from 9 to 11 carbon atoms and M¹ is a cation. The alkyl ether sulphate component has the general structure R²—(OCH₂CH₂)OSO₃₋₊M² in which R² is an alkyl having from 8 to 10 carbon atoms, y has an average value of 0.1 to 5 and M² is a cation.

As used herein, “by total surfactant weight” is intended to indicate that these proportions reflect the weight percent of active surfactant and do not include any amount of water or other unspecified ingredients present in the surfactants.

In the alkyl ether sulphate component, y is indicative of the degree of ethoxylation, with higher y values indicating more ethoxylation, and thus a greater stability of the foam. The value of y may be from 0.5-3.0. A specific y-value, such as 0.8 or 2.2 may be preferred, depending on the degree of ethoxylation (and stability) required.

M¹ and M² may be selected from sodium, ammonium, calcium, potassium, magnesium, quaternary ammonium, or a combination thereof. Also, M¹ and M² may be independently selected. For example, M¹ may be sodium and M² may be ammonium. In other forms, M¹ and M² may both be sodium or they may both be ammonium. As such, the selection of one cation may not directly influence the selection of the other cation.

The alkyls R¹ and R² may each be branched, linear or a combination thereof. Also, R¹ and R² may be independently selected. For example, R¹ may be branched, while R² may be linear, or a combination of branched and linear alkyls.

The surfactant composition disclosed herein has, unexpectedly, been shown to be suitable for use with stuccos prepared in a variety of ways. For example, the surfactant composition disclosed herein may function as a foaming agent used to form a foam that is suitable to be added to gypsum slurries that employ gypsum calcined by different methods. In this regard, the surfactant composition disclosed herein provides a versatile surfactant composition that can assist in preparing gypsum products that have consistent properties, such as weight and strength characteristics, that are manufactured in different facilities using different equipment and materials with different properties. Thus, the surfactant composition disclosed herein provides a useful subset compared to those formulations exemplified in the prior art.

In one form, the surfactant composition may comprise from 70 to 95 wt. % of the alkyl sulphate component and from 5 to 30 wt. % of the alkyl ether sulphate component; from 75 to 90 wt. % of the alkyl sulphate component and from 10 to 25 wt. % of the alkyl ether sulphate component; or, optionally, approximately 80 wt. % of the alkyl sulphate component and approximately 20 wt. % of the alkyl ether sulphate component. The respective weight percentages of alkyl sulphate component and alkyl ether sulphate component may vary depending on the degree of ethoxylation (and stability) of the alkyl ether sulphate component. For example, the more ethoxylated the alkyl ether sulphate component is (i.e. the higher the y-value is), the more stable the alkyl ether sulphate component is and less will be required in the surfactant composition.

It should also be appreciated that some of the alkyl ether sulphate component may not be ethoxylated. Thus, some of the unethoxylated alkyl ether sulphate (i.e. an alkyl sulphate) may contribute to the overall wt. % by total surfactant weight of the alkyl sulphate component in the composition. This may be true for compositions comprising a higher wt. % by total surfactant weight of an alkyl sulphate component.

In some forms, the alkyl ether sulphate component may comprise a mixture of alkyl ether sulphates of differing carbon chain lengths. For example, the alkyl ether sulphate component may comprise both alkyl ether sulphates where R² is an alkyl having 8 carbon atoms and alkyl ether sulphates where R² is an alkyl having 10 carbon atoms. The alkyl ether sulphate, where R² is an alkyl having 8 carbon atoms, may comprise approximately 45 wt. % of the alkyl ether sulphate component mixture, and the alkyl ether sulphate, where R² is an alkyl having 10 carbon atoms, may comprise approximately 55 wt. % of the alkyl ether sulphate component mixture.

In some forms, the alkyl sulphate component may comprise a mixture of alkyl sulphates of differing carbon chain lengths. For example, the alkyl sulphate component may comprise alkyl sulphates where R¹ is an alkyl having 9 carbon atoms, alkyl sulphates where R¹ is an alkyl having 10 carbon atoms and alkyl sulphates where R¹ is an alkyl having 11 carbon atoms. In one form, the alkyl sulphate component mixture may comprise approximately 18% alkyl sulphate where R¹ is an alkyl having 9 carbon atoms, approximately 42% alkyl sulphate where R¹ is an alkyl having 10 carbon atoms, and approximately 38% alkyl sulphate where R¹ is an alkyl having 11 carbon atoms, with the balance being alkyl sulphates where R¹ is an alkyl having 8 carbon atoms or less and 12 carbon atoms or more.

In some embodiments, the alkyl sulphate component and the alkyl ether sulphate component may be combined or blended prior to use of the surfactant composition. In other embodiments, the alkyl sulphate component and the alkyl ether sulphate component may remain separate, and may be separately added, either concurrently or successively, during use of the surfactant composition. Similarly, some or all of the various alkyl sulphates of the alkyl sulphate component may be combined or blended prior to use, or may remain separate and may be separately added during use of the surfactant composition. Similarly, some or all of the various alkyl ether sulphates of the alkyl ether sulphate component may be combined or blended prior to use, or may remain separate and may be separately added during use of the surfactant composition. In this regard, some or all of the subcomponents (i.e. the various alkyl sulphates and/or the various alkyl ether sulphates) of the two components may be concurrently or successively added during use of the surfactant composition. In other forms, one or more subcomponents of the alkyl sulphate component may be combined or blended with one or more subcomponents of the alkyl ether sulphate component prior to use of the surfactant composition. Any remaining subcomponents required to form the surfactant composition may remain separate and may be separately added during use of the surfactant composition, or some or all of the remaining subcomponents may be combined or blended for addition during use of the surfactant composition.

The use of a surfactant composition, as described above, as a foaming agent is also disclosed. The foaming agent may be used in the pre-generation of foam, through mixing the foaming agent (i.e. surfactant composition) with water and air, and may be suitable for use in the manufacture of a gypsum product, such as plasterboard.

In the normal process of manufacturing plasterboard, foam is generated prior to being added into the slurry. Foaming agent, water and air are mixed in a foam generator. The foaming agent and water may be combined to form a foam concentrate (also known as foam water concentrate, or simply foam water) before entering the foam generator. In this regard, the foaming agent may be added to a water line that enters the foam generator.

In one embodiment, the alkyl sulphate component and the alkyl ether sulphate component of the surfactant composition may be blended prior to being added to or mixed with water in the water line. Adding the already blended alkyl sulphate component and alkyl ether sulphate component to the water line may thus form a foam water concentrate. The foam water concentrate may then be introduced into the foam generator. Air can also be introduced into the foam generator. The amount of air introduced into the foam generator may be used to control the final foam density (i.e. the density of the foam that is to be added into the slurry). In some embodiments, a second, or even third, foam generator can be used to ensure that as much as possible of the foam water concentrate is foamed. However, it should be appreciated that the number of foam generators is not so limited.

In one embodiment, the alkyl sulphate component and the alkyl ether sulphate component of the surfactant composition may be blended prior to being introduced into the foam generator (i.e. the blended surfactant composition may be added directly into the foam generator, as opposed to being added into the water line). Water can also be introduced to the foam generator. Air can also be introduced into the foam generator. The amount of air introduced into the foam generator may be used to control the final foam density. In some embodiments, a second, or even third, foam generator can be used to ensure that as much of the foam water concentrate as possible is foamed, however the use of the surfactant composition is not so limited.

In another embodiment, the alkyl sulphate component and the alkyl ether sulphate component of the surfactant composition may be added (mixed) to the water line separately (i.e. the two components are not pre-blended), and the foam water can be introduced into the foam generator. Alternatively, there may be separate water lines such that each of the alkyl sulphate and alkyl ether sulphate components is added into a separate water line, forming separate foam waters. Air can also be introduced into the foam generator. The amount of air introduced into the foam generator may be used to control the final foam density. In some embodiments, a second, or third (plus), foam generator can be used to ensure that as much of the foam water concentrate as possible is foamed.

In another embodiment, the alkyl sulphate component and the alkyl ether sulphate component of the surfactant composition may be added into the foam generator separately (i.e. the two components are added to the foam generator via separate lines). Water can also be introduced to the foam generator. Air can also be introduced into the foam generator. The amount of air introduced into the foam generator may be used to control the final foam density. In some embodiments, a second, or even third, foam generator can be used to ensure that as much of the foam water concentrate as possible is foamed, however additional foam generators may also be used to assist in this regard.

Other embodiments of foam generation are also contemplated. For example, various subcomponents of the surfactant composition (i.e. subcomponents of the alkyl sulphate component or alkyl ether sulphate component) may be blended and added to a water line or directly to the foam generator, or may be separately added to a water line or directly to the foam generator.

The final foam density of the foam being introduced to the slurry can be controlled by the amount of air and water introduced into the foam generator(s). The foam density influences the density of the resulting plasterboard, as well as the resulting distribution of voids within the set gypsum core.

Once the foam has been generated, it can be introduced to the main slurry mixer or introduced into the slurry via a canister (and/or boot) or extractor. The foam may usually be split into two lines with some (e.g. a small portion) of the foam being introduced into the mixer or extractor, whilst the rest (e.g. majority) of the foam is introduced into the slurry via the canister and/or boot. By introducing the foam into the canister, boot or extractor, contact and mixing duration between the foam and slurry may be minimised. This can assist in preventing any unwanted rupturing of the foam before the slurry starts to set or harden. Additionally, by splitting the foam into two lines, a denser portion of the slurry (i.e. the portion of the slurry with only a small portion of foam) can be removed for forming a hard layer on the facing cover sheet prior to the remaining foam being added to the slurry to form a reduced density slurry (i.e. the slurry with the majority of the foam, and thus with more foam voids) which can then be deposited on the cover sheet/dense layer. It should be appreciated, however, that all of the foam may be introduced into the slurry, either via the main slurry mixer or via the canister and/or boot. A portion of the slurry, prior to foam addition, may still be removed for forming a hard layer on the facing cover sheet. For example, when all of the foam is being introduced into the main slurry mixer, a portion of the slurry may be removed prior to foam addition. In another example, when all of the foam is being introduced into the canister and/or boot, a portion of the slurry in the main mixer may be removed for forming a hard layer on the facing cover sheet. In yet other embodiments, no hard layer may be required.

It should also be appreciated that the alkyl sulphate component and alkyl ether sulphate component of the surfactant composition may be foamed separately. Similarly, the alkyl sulphates and alkyl ether sulphates forming the alkyl sulphate component and alkyl ether sulphate component, respectively, may be foamed separately. The resulting foams may be combined/mixed prior to addition to the mixer, extractor, boot and/or canister, or may be introduced into the mixer, extractor, boot and/or canister separately, with mixing of the various foams occurring in the mixer, extractor, boot and/or canister in conjunction with mixing of the foams into the slurry.

The gypsum slurry may otherwise be prepared in accordance with known techniques, such as those described in WO2008/112369. In this regard, stucco (calcined gypsum powder) and gauge water is added into the mixer. Other additives may also be added. While the additives may be added in dry form, where appropriate, any dry additives may be mixed with water to form a slurry thereof, prior to addition into the mixer.

Other additives which may be incorporated into the gypsum slurry may include accelerators, retarders, water reducing agents, board stiffening agents, binding agents, fibre reinforcements, waterproofing agents, etc. Accelerators may include potassium sulphate, various forms of ground gypsum (including SMA, CMA, BMA and DMA), ammonium sulphate and other sulphates. Retarders may include protein-based retarders, DTPA, citric acid, tartaric acid, etc. Water reducing agents may include dispersants, such as polynaphthalene sulphonates, lignosulphonates, polycarboxylate esters, etc. Board stiffening agents may include boric acid, tartaric acid, etc. Binding agents may include starch. The starch may be derived from corn/maize, wheat, rice, potato, tapioca, etc. The starch may be modified chemically, physically and/or genetically, such as an acid modified or oxidised starch. Fibre reinforcements may include paper pulp, glass or other synthetic fibres such as polypropylene, PVA fibres, polyacrylic fibres, etc. Waterproofing agents may include siloxanes, siliconates, waxes, metallic resonates, asphalt, etc.

Gypsum products, such as plasterboards, prepared using the surfactant composition, as described above, are also disclosed. Such plasterboards have been shown to have decreased weight, whilst maintaining adequate strength characteristics, such as nail pull resistance and edge hardness. Nail pull resistance measures a combination of the gypsum core board strength, the strength of the paper cover sheets and the strength of the bond between the paper and the gypsum. In order for 10 mm plasterboard to meet Australian and New Zealand Standard AS/NZS 2588, the board must achieve a minimum nail pull resistance of 270 N and a minimum edge hardness, as measured by a penetrometer, of 45 N. AS/NZS 2588 dictates that other properties, such as sag and flexural strength must also meet minimum standards (including where that minimum standard is a measurement which cannot be exceeded). However, as the weight of plasterboard is reduced, it is generally accepted that meeting the minimums required of the nail pull resistance and penetrometer tests are the predominant limiting factors on a given board meeting the AS/NZS 2588 standards. As such, it is generally accepted that where a board passes the nail pull resistance and penetrometer minimums, the board will pass the sag and flexural strength tests.

The surfactant composition disclosed herein has been shown to be suitable for producing plasterboard having decreased weight, whilst maintaining adequate strength characteristics.

### BRIEF DESCRIPTION OF THE DRAWINGS

Notwithstanding any other forms which may fall within the scope of the compositions, methods and products as set forth in the Summary, specific embodiments will now be described, by way of example only, with reference to the accompanying drawings in which:

FIG. 1 shows a schematic flow sheet for an embodiment of a method of manufacturing plasterboard;

FIG. 2 shows a schematic diagram of an embodiment of a plasterboard manufacturing process;

FIG. 3 shows a schematic flow sheet for an embodiment of a method of forming foam for introduction into a gypsum slurry;

FIG. 4 shows a schematic flow sheet for an embodiment of an alternative method of forming foam for introduction into a gypsum slurry;

FIGS. 5 and 6 show representative images of the front and back face of the set gypsum core of Sample A1;

FIGS. 7 and 8 show representative images of the front and back face of the set gypsum core of Sample B7;

FIGS. 9 and 10 show representative images of the front and back face of the set gypsum core of Sample B8;

FIGS. 11 and 12 show representative images of the front and back face of the set gypsum core of Sample C1;

FIGS. 13 and 14 show representative images of the front and back face of the set gypsum core of Sample D11;

FIGS. 15 and 16 show representative images of the front and back face of the set gypsum core of Sample E1; and

FIGS. 17 to 22 show, sequentially, representative images of the front and back face of the set gypsum core of three comparative plasterboards R, S and T.

### DETAILED DESCRIPTION

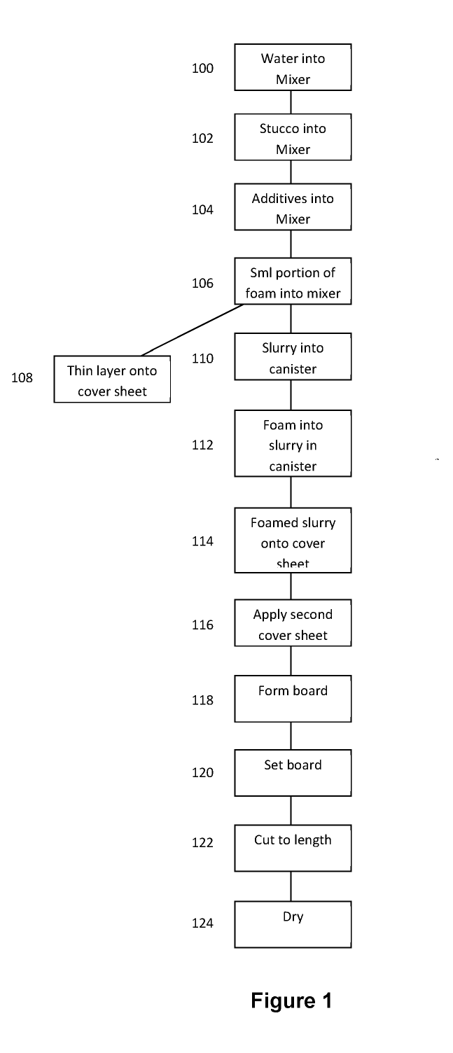

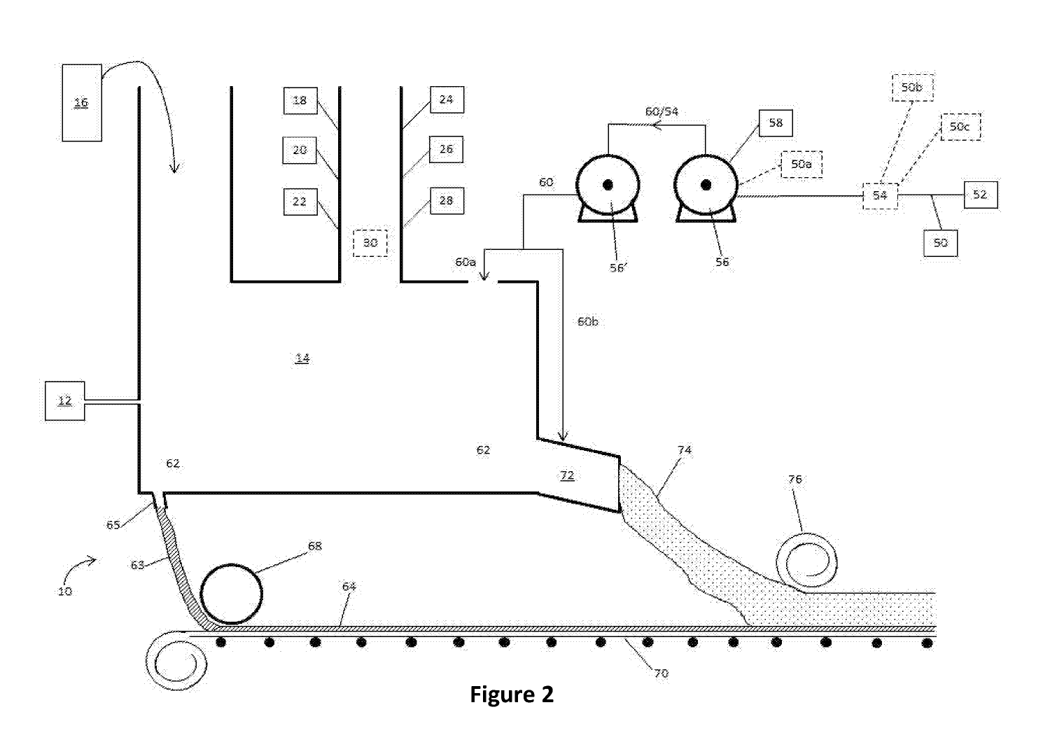

Referring firstly to FIGS. 1 and 2, a schematic flow sheet and a schematic diagram of a plasterboard manufacturing process 10 are shown. An exemplary formulation for preparing plasterboard, including various ranges of additives, is set out in Table 1. The general formulation provided in Table 1 can be used in the manufacture of plasterboards in accordance with process 10, shown in FIGS. 1 and 2.

TABLE 1

| | Approx. Formulation | |
|---|---|---|
| Stucco | 4000-5000 | gsm |
| Accelerator | 5-100 | gsm |
| Retarder | 0.1-2.0 | gsm |
| Potassium Sulphate | 5-50 | gsm |
| Starch | 45-80 | gsm |
| Foaming Agent | 2-8 | gsm |
| Paper Pulp | 15-25 | gsm |
| Water Reducing Agent | 12-25 | gsm |
| Boric Acid | 16-22 | gsm |

The ranges provided in Table 1 are intended to provide indicative ranges of additives suitable for inclusion in a foamed gypsum slurry for manufacturing a gypsum product, such as plasterboard. Those skilled in the art will readily understand that different additives may interact in the foamed gypsum slurry in different ways, and that processing conditions may alter the amount of a specific additive required. For example, it is known that the way in which gypsum is calcined imparts different properties to the resulting stucco. As a consequence of those different properties, the amount of e.g. accelerator, retarder, water, etc., required can vary. Those skilled in the art will also readily understand that the amount of the different additives may also be varied, depending on the properties required of the resultant plasterboard.

The plasterboard manufacturing process 10 may be best described with reference to the various steps of the process. As shown in FIGS. 1 and 2, at step 100, water 12, also known as gauge water, is added into the mixer 14 (e.g. via a pipe or other line). At step 102, stucco 16 is added into the mixer. The order of addition of stucco and gauge water is not critical, and both may be added simultaneously. Prior to being added into the mixer 14, other dry ingredients, such as accelerators, may have been mixed in with the stucco 16. At step 104, other additives 18, 20, 22, 24, 26, 28 are optionally introduced into the mixer 14. Whilst six different additive types are shown in FIG. 2, it should be appreciated that more, or less, additives may be introduced into the mixer 14, depending on the intended application of the resulting gypsum product. Also, it should be appreciated that the additives may be combined (e.g. as shown at 30 in FIG. 2), or may be introduced independently into the mixer 14. Additionally, the additives (either together or separately) may be mixed with water prior to being added to the mixer.

The use of various additives is contemplated. For example, accelerators 18 may include various forms of ground gypsum (including SMA, CMA, BMA and DMA), ammonium sulphate, potassium sulphate and other sulphates. In some forms, ground gypsum may be introduced into the mixer 14 with the stucco 16, but additional accelerators 18, such as potassium sulphate, may be added into the mixer 14 separately to the stucco 16. In this regard, the potassium sulphate referred to in Table 1 above may also be an accelerator, and the formulation may be considered to include two different types of accelerator.

Retarders 20 may also be introduced into the mixer 14 as an additive, and may include protein-based retarders, DTPA, citric acid, tartaric acid, etc. Starch 22, used as a binding agent to assist in bonding cover sheets to the core, may also be introduced into the mixer 14 as an additive. The starch 22 may be derived from corn/maize, rice, wheat, potato, tapioca, etc. The starch may be chemically, physically and/or genetically modified, such as an acid modified or oxidised starch.

A fibre reinforcement additive 24 may also be introduced into the mixer 14 as an additive. Whilst paper pulp is specifically referred to in Table 1, it should be appreciated that other fibre reinforcements 22 may be included in the gypsum slurry, including glass or other synthetic fibres, polypropylene, PVA fibres, polyacrylic fibres, etc.

Water reducing agents 26 are another type of additive that may be introduced into the mixer 14. Water reducing agents 26 may include dispersants, such as polynaphthalene sulphonates, lignosulphonates, polycarboxylate esters, etc.

Additionally, board stiffening agents 28 may be introduced into mixer 14 as an additive. Whilst boric acid is one form of board stiffening agent (that is specifically referred to in Table 1), it should be appreciated that other board stiffening agents 28 such as tartaric acid, etc. may be used in place of, or in conjunction with, the boric acid.

Whilst not shown in Table 1 (nor specifically identified in FIG. 2), other additives, such as waterproofing agents, may also be included in the gypsum slurry formulation. Such waterproofing agents may include siloxanes, siliconates, waxes, metallic resonates, asphalt, etc.

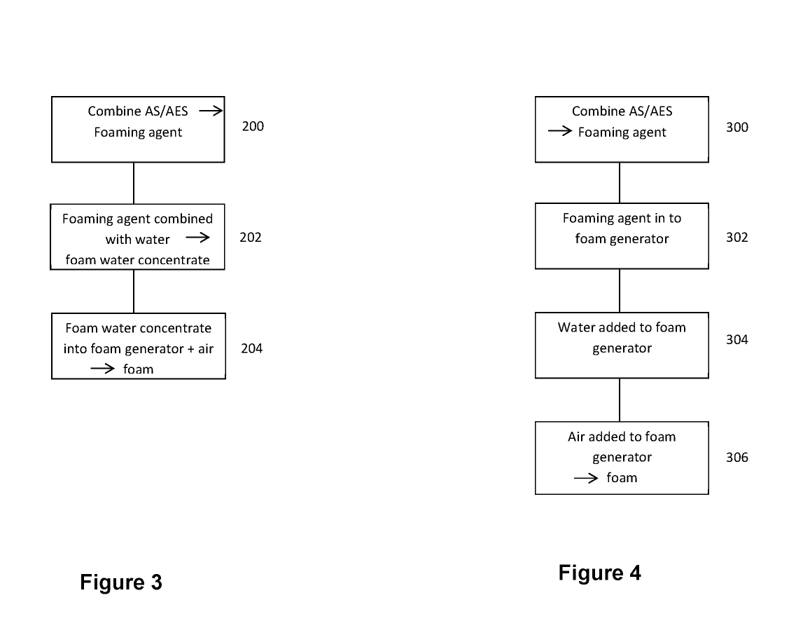

In addition to these additives, the gypsum slurry formulation shown in Table 1 comprises a foaming agent. The foaming agent may otherwise be one of the surfactant compositions disclosed herein. A foam is prepared from the foaming agent, and reference is now made to FIG. 3, which shows a schematic flow sheet for a method of forming foam, and FIG. 2, which shows foam formation as part of the process of manufacturing plasterboard.

At step 200 of FIG. 3, the alkyl sulphate component and alkyl ether sulphate component are combined to form a foaming agent 50. At step 202, the foaming agent 50 is combined with water 52 to form a foam water concentrate 54. At step 204, the foam water concentrate 54 is added into a foam generator 56. Air 58 is also added into the foam generator 56 to generate foam 60 from the foam water concentrate 54. In FIG. 2, the foam 60 and any unfoamed foam water concentrate 54 are directed into a second foam generator 56′. The second foam generator 56′, whilst potentially not necessary, is used to improve the foaming efficiency of the foam water concentrate 54. If required, one or more additional foam generators may be employed.

An alternative method of forming a foam is detailed in a schematic flow sheet shown in FIG. 4. At step 300, the alkyl sulphate component and alkyl ether sulphate component are combined to form a foaming agent 50a. At step 302, the foaming agent 50a is added into the foam generator 56. Water 52 is also added into the foam generator 56, at step 304, followed by air 58 in step 306. This results in a foam 60 being formed. It should also be noted that both FIGS. 3 and 4 refer to the foaming agent 50/50a having already been blended. It should be appreciated that the various components (e.g. the alkyl ether sulphate component and the alkyl sulphate component) can be added to the water or foam generator separately. For example, foaming agents 50b and 50c in FIG. 2 are shown as being added to the water 52, to form the foam water concentrate 54. Alternatively, the two foaming agents 50b and 50c could be added to the foam generator 56 (not shown).

The generated foam 60, at step 206, is then added into the gypsum slurry. In some embodiments, such as the one shown in FIGS. 1 and 2, a portion of the generated foam 60a is introduced into the mixer 14 (step 106), forming a slurry 62. At step 108 a small portion 63 of slurry 62 is removed from the mixer, via extractor 65, and deposited as a thin layer 64 onto a facing cover sheet 66. A roller 68 can be used so that thin layer 64 is substantially uniform. This facing cover sheet 66 with thin layer 64 of slurry 62 moves along a belt line 70 ready for the next stage. In the meantime, at step 110, slurry 62 is moved into canister 72 in preparation for being deposited onto the facing cover sheet (i.e. on top of thin layer 64). At step 112, the remainder of the generated foam 60b is introduced into the slurry 62 in canister 72, forming a foamed slurry 74. In other embodiments (not shown), as will be appreciated by those skilled in the art, all of the foam may be introduced into the canister. In such embodiments, no foam will be introduced to the mixer. A thin layer of the slurry in the mixer may be deposited onto the facing cover sheet, as described above, to form a denser layer of gypsum at the facing cover sheet. In yet other embodiments (not shown), as will also be appreciated by those skilled in the art, some generated foam may be added to the slurry in the extractor, to again be used to form a thin denser layer at the facing cover sheet, with the majority of the foam being added to the slurry in either the mixer, boot or canister.

The foamed slurry 74, at step 114, is then deposited onto the facing cover sheet 66, on top of the thin layer 64 of slurry 62. A backing cover sheet 76 is then applied, at step 116. The application of the backing cover sheet 76 can assist in providing plasterboard with a substantially uniform thickness, although an additional apparatus, such as a roller, may be employed to further assist in this regard.

The cover sheets 66, 76 may be any suitable cover sheet material known in the art, including fibre mats (such as glass fibre mats), and paper. The same, or different, materials can be used for the facing cover sheet 66 and the backing cover sheet 76. For example, paper may be used for both the facing and backing cover sheets 66, 76, although paper of different grammage may be used (e.g. a heavier paper may be used for the facing cover sheet, and a lighter paper may be used for the backing cover sheet). In another example, a glass fibre mat may be used as the facing cover sheet and paper may be used as the backing cover sheet.

Further board forming processes, such as forming the board edges and gluing of the cover sheets, may occur at step 118. The board will then continue along the board line, allowing the gypsum core to set (step 120). Once set, the board can be cut to appropriate lengths (step 122), and then dried (step 124).

Drying usually entails at least two drying stages, although additional drying stages can also be employed. The cut boards are passed through dryers (ovens) to remove excess water. Once dried, the boards are ready for storage and subsequent distribution.

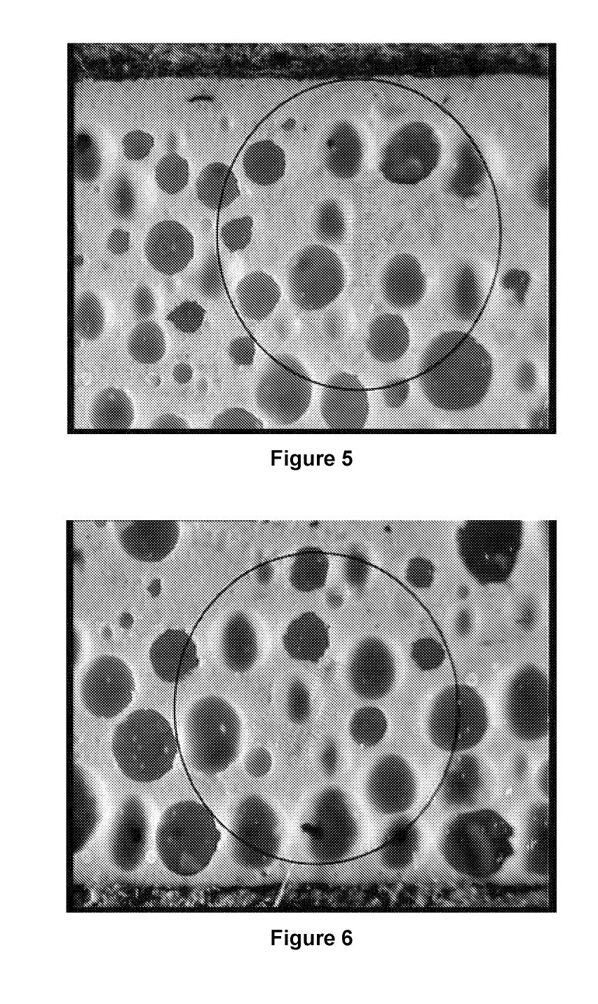

FIGS. 5 to 16 show, sequentially, images of the front and back faces of the set gypsum core of six plasterboards prepared in accordance with the present disclosure.

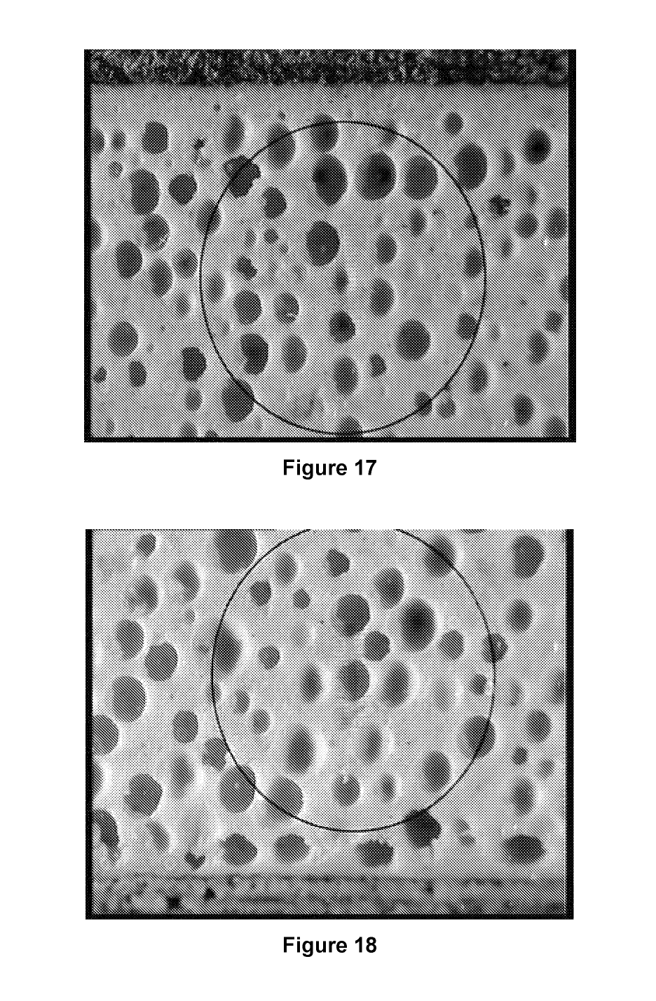

FIGS. 17 to 22 show, sequentially, images of the front and back faces of the set gypsum core of three comparative plasterboards. These Figures will be described in more detail in the Examples and, in particular, in Example 7.

### EXAMPLES

Non-limiting Examples of exemplary surfactant compositions and their use as a foaming agent in the manufacture of gypsum products will now be described. Example 1 describes exemplary surfactant compositions and Example 2 describes the use of such foaming agents in the preparation of laboratory gypsum boards to exemplify their suitability to form lightweight gypsum boards. The formulations used in preparing the laboratory boards in Example 2 are shown in Table 2.

TABLE 2

| | Laboratory Board Formulation A | |
|---|---|---|
| Stucco | 500 | g |
| Accelerator | 4 | g |
| Retarder | 0.18 | g |
| Potassium Sulphate | 1.0 | g |
| Starch | 5.3 | g |
| Foaming Agent | 1.2 | g |
| Water Reducing Agent | 2 | g |
| Boric Acid | 1.5 | g |

Examples 3 to 6 describe the use of such foaming agents in the manufacture of plasterboard in a plasterboard manufacturing plant (as opposed to the sample plasterboards prepared in a laboratory, in Example 2). The formulations used in preparing the sample plasterboards in Examples 3 to 6 are shown in Table 3.

TABLE 3

| | Formulation A | | Formulation B | | Formulation C | | Formulation D | | Formulation E | |
|---|---|---|---|---|---|---|---|---|---|---|
| Stucco | 4550 | gsm | 4550 | gsm | 4250 | gsm | 4550 | gsm | 4500 | gsm |
| Accelerator | 8 | gsm | 7 | gsm | 7 | gsm | 40 | gsm | 75 | gsm |
| Retarder | 0.7 | gsm | 0.9 | gsm | 0.9 | gsm | 1.1 | gsm | 1.4 | gsm |
| Potassium Sulphate | 10 | gsm | 10 | gsm | 10 | gsm | 31 | gsm | 20 | gsm |
| Starch | 50 | gsm | 50 | gsm | 50 | gsm | 50 | gsm | 45 | gsm |
| Foaming Agent | 4 | gsm | 3.5 | gsm | 3.5 | gsm | 4 | gsm | 5.3 | gsm |
| Paper Pulp | 20 | gsm | 20 | gsm | 20 | gsm | 20 | gsm | 15 | gsm |
| Water Reducing Agent | 15 | gsm | 15 | gsm | 15 | gsm | 18 | gsm | 20 | gsm |
| Boric Acid | 18 | gsm | 18 | gsm | 18 | gsm | 18 | gsm | 18 | gsm |

Formulation differences (such as the amount of various additives employed) was attributable to, amongst other things, the way in which the stucco was prepared. The stucco used in Formulations A, B and C was prepared by flash calcination, using the Calcidyne™ process. In the Calcidyne™ process the gypsum is ground into a powder prior to being calcined. The stucco used in Formulation D was prepared by flash calcination, using an impact (imp) mill process where grinding and calcining of the gypsum occur in one step. The stucco used in Formulation E was prepared by the continuous kettle calcination of ground gypsum. This is a slower process than the two different flash calcination methods identified above.

It was noted that the different calcination methods can result in different ratios of stucco constituents (unburnt gypsum, hemihydrate, soluble anhydrite and insoluble anhydrite), which also results in different properties of the stucco, including acceleration rates and water requirements.

### Example 1

Surfactant compositions were prepared in accordance with the present disclosure. The compositions are shown in Table 4.

As will be explained below, these surfactant compositions were observed to be suitable for use with stuccos calcined by the different methods as outlined above with respect to Formulations A to E, and were able to produce plasterboard having decreased weight and adequate strength characteristics.

TABLE 4

| | Composition | Composition | Composition | Composition | Composition | Composition | Composition |
|---|---|---|---|---|---|---|---|
| | A | B | C | D | E | F | G |
| Alkyl sulphate | 65 wt. % | 70 wt. % | 75 wt. % | 80 wt. % | 85 wt. % | 90 wt. % | 95 wt. % |
| component | (by total | (by total | (by total | (by total | (by total | (by total | (by total |
| R¹—OSO₃^{- +}M¹ | surfactant | surfactant | surfactant | surfactant | surfactant | surfactant | surfactant |
| | weight) | weight) | weight) | weight) | weight) | weight) | weight) |
| R¹: C9 alkyl; M¹: | 18% (of the total alkyl sulphate component weigth) | | | | | | |
| sodium | | | | | | | |
| R¹: C10 alkyl; | 42% (of the total alkyl sulphate component weigth) | | | | | | |
| M¹: sodium | | | | | | | |
| R¹: C11 alkyl; | 38% (of the total alkyl sulphate component weigth) | | | | | | |
| M¹: sodium | | | | | | | |
| R¹: ≤C8 alkyl | 2% (of the total alkyl sulphate component weigth) | | | | | | |
| & ≥C12 alkyl; | | | | | | | |
| M¹: sodium | | | | | | | |
| Alkyl ether | 35 wt. % | 30 wt. % | 25 wt. % | 20 wt. % | 15 wt. % | 10 wt. % | 5 wt. % |
| sulphate | (by total | (by total | (by total | (by total | (by total | (by total | (by total |
| component | surfactant | surfactant | surfactant | surfactant | surfactant | surfactant | surfactant |
| R²—(OCH₂CH₂)ₓ | weight) | weight) | weight) | weight) | weight) | weight) | weight) |

| | |
|---|---|
| R²: C8 alkyl; M²: | 45% (of the total alkyl ether sulphate component weigth); y: 0.8 |
| ammonium | |
| R²: C10 alkyl; M²: | 55% (of the total alkyl ether sulphate component weigth); y: 0.8 |
| ammonium | |

### Example 2

Laboratory Sample plasterboards LS1 to LS6 of typical paper-covered gypsum boards produced in accordance with the present disclosure were prepared to evaluate various ratios of components in the surfactant composition. Laboratory Board Formulation A, shown in Table 2, was used to prepare the Laboratory Sample boards. The stucco in Laboratory Board Formulation A had been prepared by flash calcination, using the Calcidyne™ process.

Laboratory Sample boards LS1 to LS6 were prepared using surfactant Compositions A to F, as shown in Table 4, as the Foaming Agent. The various components of each of the surfactant Compositions (i.e. the alkyl sulphate component and the alkyl ether sulphate component) had been pre-blended/combined, prior to being used as the respective Foaming Agents.

The water reducing agent, boric acid, potassium sulphate, starch, retarder and water (i.e. the ‘wet’ ingredients) were mixed together in a Hobart mixer. The stucco and accelerator (i.e. the ‘dry’ ingredients) were mixed together in a separate container. The Foaming Agent was added to water in a Hamilton Beach milkshake blender cup.

The dry ingredients were added to the wet ingredients. After 20 seconds, the Foaming Agent and water was blended by the Hamilton Beach blender for 10 seconds and then stopped, to form the foam. It will be understood that not all of the Foaming Agent may form foam. As the blender was stopped, the Hobart mixer was started to form the unfoamed slurry. Mixing was stopped after 10 seconds and, over a period of 5 seconds, the foam was added to the unfoamed slurry. Again, it will be understood that not all of the formed foam (or any unfoamed Foaming Agent) may be added to the unfoamed slurry. The Hobart mixer was started again and stopped after 5 seconds, having formed the (foamed) slurry.

The slurry was cast into a pre-prepared mould lined with 200 gsm paper sheet. After the Laboratory Sample board had set and hardened, an end of the board was trimmed so that the board had a dimension of 305 mm×305 mm×10 mm. The board was then dried in an oven and conditioned. Laboratory Sample boards LS1 to LS6 were each prepared in this manner. The board weight and nail pull resistance of each Laboratory Sample board was determined, and is shown in Table 5. In order to compare the different surfactant compositions, the normalised (to a board weight of 5.5 kg/m²) nail pull resistance for each Laboratory Sample board was also determined, and shown in Table 5.

TABLE 5

| | Surfactant | | | | | |
|---|---|---|---|---|---|---|
| | Composition | Brd | Nail Pull Resistance (N) | | | |
| | (from | Wt | | | | Norm. (to |
| Sample | Table 4) | kg/m² | 1 | 2 | Avg | 5.5 kg/m²) |
| LS1 | A | 5.44 | 206.9 | 233.2 | 220.1 | 222 |
| LS2 | B | 5.43 | 206.4 | 213.9 | 210.2 | 213 |
| LS3 | C | 5.52 | 229.0 | 227.3 | 228.2 | 227 |
| LS4 | D | 5.30 | 236.2 | 231.6 | 233.9 | 243 |
| LS5 | E | 5.32 | 230.1 | 239.1 | 234.6 | 242 |
| LS6 | F | 5.31 | 228.6 | 231.0 | 229.8 | 238 |

Even though the actual and normalised nail pull resistance are both below the AS/NZS 2588 minimum of 270 N, it was observed and understood that plasterboard samples prepared in a laboratory (such as Laboratory Sample boards LS1 to LS6) will generally have lower nail pull resistance, etc., than plasterboard manufactured in a plasterboard manufacturing plant. Nonetheless, the Laboratory Sample boards were useful in establishing that the surfactant compositions disclosed herein were suitable to use in manufacturing lightweight gypsum board with adequate strength characteristics.

Based on these results, surfactant Composition D (from Table 4) was selected to be used in preparing sample plasterboards (as explained below, in Examples 3 to 6) in a plasterboard manufacturing plant, to exemplify the suitability of the surfactant compositions disclosed herein to be used with stuccos prepared in a variety of ways. It should be appreciated that whilst only surfactant Composition D has been exemplified in Examples 3 to 6, other surfactant compositions, such as those disclosed in Table 4, were also suitable.

### Example 3

Sample plasterboards A1 to A7 were prepared in accordance with the schematic flow sheet and schematic diagram for a plasterboard manufacturing process shown in FIGS. 1 and 2, using Formulation A as shown in Table 3 (i.e. the samples were manufactured in a plasterboard manufacturing plant). The stucco in Formulation A had been prepared by flash calcination, using the Calcidyne™ process.

The Foaming Agent was surfactant Composition D shown in Table 4. The various components of the Foaming Agent (i.e. the alkyl sulphate component and the alkyl ether sulphate component) had been pre-blended, and the Foaming Agent was pumped into the water line to form a foam water that was then introduced into the foam generator, along with air, to generate the foam. Two foam generators were used to maximise foam generation and minimise the amount of unfoamed foam water concentrate being introduced into the slurry. A portion of the foam was directed into the main mixer, with the remaining foam being directed into the canister. The flow sheet and manufacturing process were otherwise followed to form plasterboard Samples A1 to A7.

Samples A1 to A7 were prepared using 220 gsm face paper sheet and 160 gsm back paper sheet. Boards 10 mm thick were prepared, and the board weight for each sample was determined. Various properties of the resulting plasterboard Samples A1 to A7 are shown in Tables 6 to 9, including results for nail pull resistance (AS/NZS 2588 minimum of 270N), penetrometer (AS/NZS 2588 minimum of 45N), bending strength in the machine direction (AS/NZS 2588 minimum of 360N), and bending strength in the cross direction (AS/NZS 2588 minimum of 150N). The tests were conducted, and results provided in these tables, merely to indicate that Samples A1 to A7 prepared in this example meet various AU/NZ Standards for gypsum plasterboard.

TABLE 6

| | Brd Wt | Nail Pull Resistance (N) | | | | | | |
|---|---|---|---|---|---|---|---|---|
| Sample | kg/m² | 1 | 2 | 3 | 4 | 5 | 6 | Avg |
| A1 | 5.66 | 276.7 | 312.7 | 274.9 | 266.7 | 301.5 | 282.1 | 285.8 |
| A2 | 5.67 | 294.6 | 295.7 | 285.2 | 291.5 | 301.0 | 260.7 | 288.1 |
| A3 | 5.66 | 269.8 | 275.0 | 291.1 | 280.8 | 291.4 | 287.4 | 282.6 |
| A4 | 5.70 | 305.7 | 294.1 | 308.5 | 284.9 | 317.9 | 276.8 | 298.0 |
| A5 | 5.74 | 294.7 | 269.8 | 285.1 | 293.0 | 271.4 | 286.3 | 283.4 |
| A6 | 5.57 | 294.3 | 280.2 | 257.0 | 266.2 | 300.6 | 261.9 | 276.7 |
| A7 | 5.68 | 283.8 | 289.3 | 258.2 | 271.4 | 279.2 | 280.6 | 277.1 |

TABLE 7

| | Penetrometer (N) | | | | | | | |
|---|---|---|---|---|---|---|---|---|
| Sample | Top | Top | Top | Avg | Bot | Bot | Bot | Avg |
| A1 | 67.3 | 73.9 | 73.9 | 71.7 | 66.3 | 71.9 | 71.9 | 70.0 |
| A2 | 71.9 | 79.1 | 84.7 | 78.6 | 68.3 | 75.5 | 75.5 | 73.1 |
| A3 | 68.0 | 72.6 | 72.6 | 71.1 | 69.0 | 69.3 | 69.3 | 69.2 |
| A4 | 68.3 | 74.8 | 85.0 | 76.0 | 73.5 | 76.8 | 76.8 | 75.7 |
| A5 | 69.6 | 83.0 | 84.7 | 79.1 | 71.9 | 74.8 | 79.7 | 75.5 |
| A6 | 75.5 | 81.1 | 81.1 | 79.2 | 63.4 | 73.9 | 73.9 | 70.4 |
| A7 | 67.7 | 77.8 | 77.8 | 74.4 | 65.0 | 73.5 | 73.5 | 70.7 |

TABLE 8

| | Brd Wt | Bending Strength (Machine Direction) (N) | | | | |
|---|---|---|---|---|---|---|
| Sample | kg/m² | Face Up | | Face Down | | Avg |
| A3 | 5.66 | 424.9 | 423.8 | 446.5 | 456.2 | 437.9 |
| A4 | 5.70 | 410.5 | 410.7 | 438.7 | 436.8 | 424.2 |

TABLE 9

| | Brd Wt | Bending Strength (Cross Direction) (N) | | | | |
|---|---|---|---|---|---|---|
| Sample | kg/m² | Face Up | | Face Down | | Avg |
| A3 | 5.66 | 166.9 | 175.2 | 200.6 | 192.7 | 183.9 |
| A4 | 5.70 | 162.8 | 162.4 | 197.2 | 199.2 | 180.4 |

FIGS. 5 and 6 show, respectively, images of the front and back faces of the set gypsum core of Sample A1, a board having a weight of 5.66 kg/m². The denser layer of slurry that contained only a portion of foam can be clearly seen adjacent to the face paper in FIG. 5 for Sample A1. FIGS. 17 and 18 show a comparative, heavier (6.21 kg/m²), board R prepared using the same stucco, but with a different foaming agent. When FIGS. 17 and 18 were compared with FIGS. 5 and 6, it was apparent that a number of large voids were present in the set gypsum core of Sample A1, which assisted in reducing the weight of the plasterboard, but without detrimentally altering strength performance characteristics.

### Example 4

Sample plasterboards B1 to B9 were prepared in accordance with the schematic flow sheet and schematic diagram for a plasterboard manufacturing process shown in FIGS. 1 and 2, using Formulation B, as shown in Table 3 (i.e. the samples were manufactured in a plasterboard manufacturing plant). Sample plasterboard C1 was also prepared in accordance with the schematic flow sheet and schematic diagram for a plasterboard manufacturing process shown in FIGS. 1 and 2, using Formulation C, as shown in Table 3 (i.e. the sample was manufactured in a plasterboard manufacturing plant). The stucco in Formulations B and C were each prepared by flash calcination, using the Calcidyne™ process, in a similar manner to the stucco used in Formulation A.

The main difference between Formulations B and C was the reduction in stucco. The stucco content was reduced in order to exemplify that lighter weight plasterboards could be produced, whilst maintaining adequate strength characteristics. In each of Samples B1 to B9 and C1, the Foaming Agent was surfactant Composition D shown in Table 4. The sample boards were prepared in a similar manner to that described in Example 3.

Samples B1 to B7 were prepared using 220 gsm face paper sheet and 160 gsm back paper sheet. Samples B8, B9 and C1 were prepared using 235 gsm face paper sheet and 160 gsm back paper sheet. Boards 10 mm thick were prepared, and the board weight for each sample was determined. Nail pull resistance and penetrometer were tested in accordance with AS/NZS 2588. It should be noted that a minimum nail pull resistance of 270N and a minimum penetrometer of 45N must be achieved in order to meet the Australian and New Zealand Standards AS/NZS 2588. Tables 10 and 11 respectively show the results of nail pull resistance and penetrometer testing conducted on Samples B1 to B7.

TABLE 10

| | Brd Wt | Nail Pull Resistance (N) | | | | | | |
|---|---|---|---|---|---|---|---|---|
| Sample | kg/m² | 1 | 2 | 3 | 4 | 5 | 6 | Avg |
| B1 | 5.61 | 271.5 | 283.5 | 291.2 | 285.2 | 285.9 | 259.4 | 279.5 |
| B2 | 5.68 | 272.1 | 273.4 | 273.6 | 301.6 | 284.9 | 284.9 | 281.8 |
| B3 | 5.68 | 284.4 | 291.8 | 269.4 | 281.0 | 285.0 | 261.2 | 278.8 |
| B4 | 5.63 | 302.9 | 307.5 | 263.8 | 255.8 | 280.1 | 285.7 | 282.6 |
| B5 | 5.78 | 289.1 | 302.3 | 320.5 | 289.9 | 300.1 | 297.0 | 299.8 |
| B6 | 5.73 | 290.1 | 283.1 | 286.3 | 264.8 | 277.1 | 278.9 | 280.1 |
| B7 | 5.71 | 298.9 | 275.7 | 275.3 | 267.1 | 265.9 | 302.5 | 280.9 |

TABLE 11

| | Penetrometer (N) | | | | | | | |
|---|---|---|---|---|---|---|---|---|
| Sample | Top | Top | Top | Avg | Bot | Bot | Bot | Avg |
| B1 | 68.3 | 72.2 | 84.7 | 75.1 | 63.7 | 73.9 | 73.9 | 70.5 |
| B2 | 65.7 | 72.9 | 72.9 | 70.5 | 67.3 | 68.0 | 68.0 | 67.8 |
| B3 | 61.8 | 71.6 | 71.6 | 68.3 | 69.6 | 69.6 | 74.2 | 71.1 |
| B4 | 67.3 | 69.0 | 76.5 | 70.9 | 64.7 | 71.9 | 71.9 | 69.5 |
| B5 | 69.3 | 76.5 | 76.5 | 74.1 | 69.6 | 76.2 | 76.2 | 74.0 |
| B6 | 65.7 | 77.8 | 77.8 | 73.8 | 70.3 | 73.5 | 73.5 | 72.4 |
| B7 | 69.0 | 82.0 | 82.0 | 77.7 | 63.4 | 69.0 | 73.5 | 68.6 |

As noted above, Samples B8 and B9 were prepared using Formulation B, with 235 gsm face paper sheet and 160 gsm back paper sheet, and Sample C1 was prepared using Formulation C, with 220 gsm face paper sheet and 160 gsm back paper sheet. The nail pull resistance results, and penetrometer results, shown in Tables 12 and 13 respectively, allow Sample B8 and Samples B2, B3 or B7 (all with similar board weights) to be compared. A marked increase in nail pull resistance was observed when the heavier grammage face paper was used. Similarly the effect of board weight on nail pull resistance was apparent, with a corresponding decrease in nail pull resistance when board weight was reduced (even with the higher grammage face paper). Based on the nail pull resistance results, it was surmised that a further reduction in board weight may be achieved.

TABLE 12

| | Brd Wt | Nail Pull Resistance (N) | | | | | | |
|---|---|---|---|---|---|---|---|---|
| Sample | kg/m² | 1 | 2 | 3 | 4 | 5 | 6 | Avg |
| B8 | 5.69 | 311.8 | 299.0 | 276.3 | 309.0 | 294.3 | 293.2 | 297.3 |
| B9 | 5.65 | 298.5 | 282.3 | 298.9 | 290.5 | 286.7 | 279.4 | 289.4 |
| C1 | 5.45 | 288.1 | 289.7 | 260.8 | 291.8 | 297.9 | 282.3 | 285.1 |

TABLE 13

| | Penetrometer (N) | | | | | | | |
|---|---|---|---|---|---|---|---|---|
| Sample | Top | Top | Top | Avg | Bot | Bot | Bot | Avg |
| B8 | 69.9 | 71.6 | 75.2 | 72.2 | 70.9 | 73.5 | 73.5 | 72.6 |
| B9 | 71.6 | 71.6 | 71.6 | 71.6 | 44.1 | 44.8 | 47.7 | 45.5 |
| C1 | 62.8 | 68.6 | 69.9 | 67.1 | 69.3 | 69.3 | 76.2 | 71.6 |

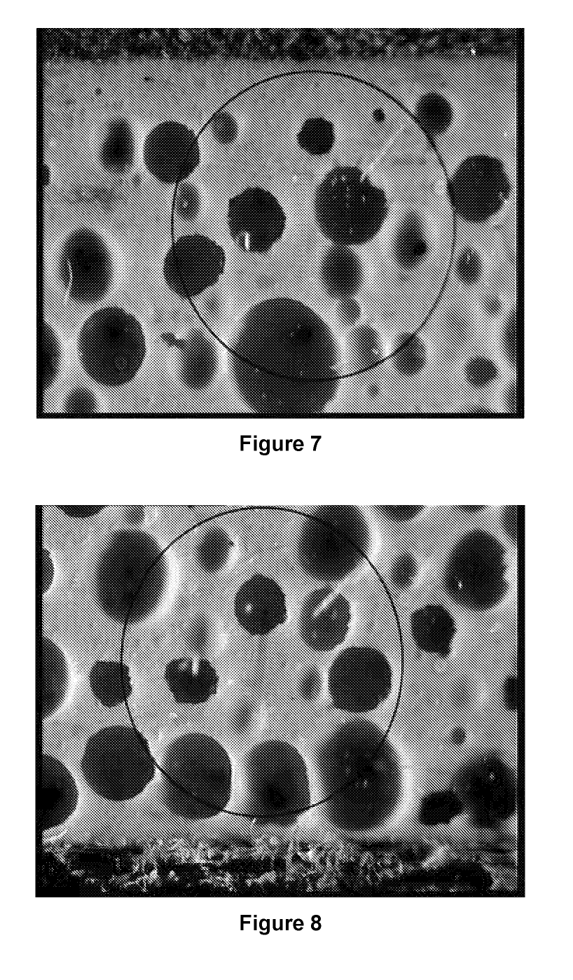

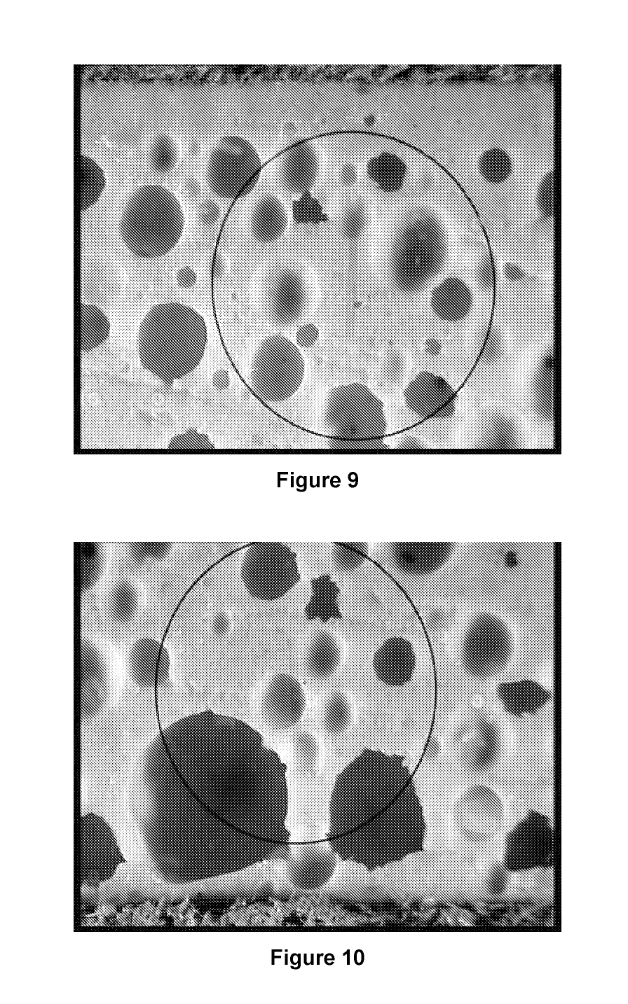

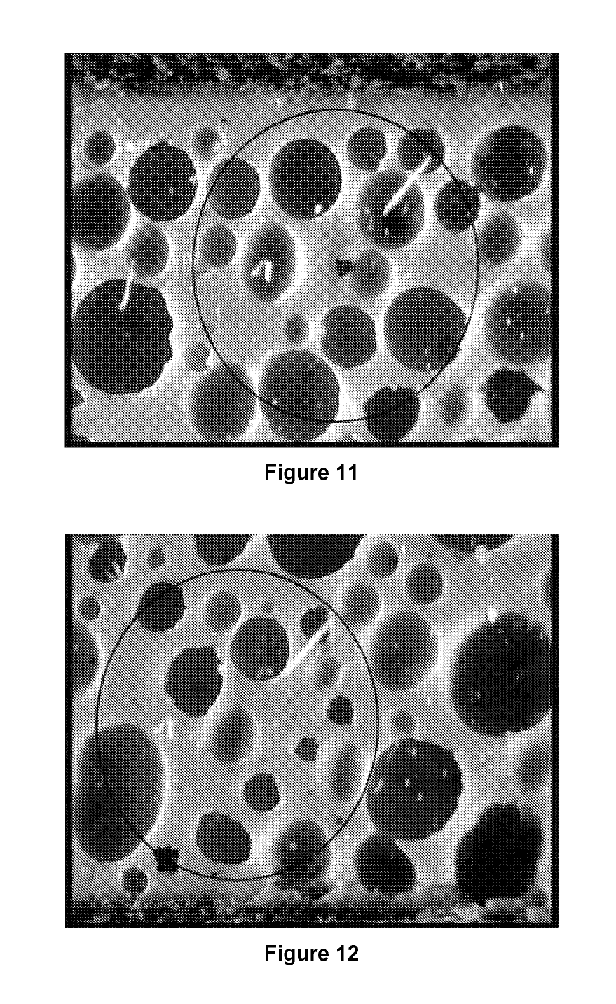

FIGS. 7 and 8 show, respectively, images of the front and back faces of the set gypsum core of Sample B7, a board having a weight of 5.71 kg/m². FIGS. 9 and 10 show, respectively, images of the front and back faces of the set gypsum core of Sample B8, a board having a weight of 5.69 kg/m², and FIGS. 11 and 12 show, respectively, images of the front and back faces of the set gypsum core of Sample C1, a board having a weight of 5.45 kg/m². The denser layer of slurry that contained only a portion of foam can be clearly seen adjacent to the face paper in FIGS. 7, 9 and 11 for Samples B7, B8 and C1, respectively. The reduction in weight between Samples B8 and C1 is apparent when comparing the set gypsum cores shown in FIGS. 9 and 10 with those shown in FIGS. 11 and 12, with voids consistently larger in size being readily noticeable in FIGS. 11 and 12. Despite this weight reduction, Sample C1 still met the two main strength requirements in the Australian and New Zealand Standards AS/NZS 2588, as shown in Tables 12 and 13. This may also be attributable to the heavier grammage paper used with Samples B8 and B9.

Again, when FIGS. 11 and 12 are compared with FIGS. 17 and 18 (which show a comparative, heavier (6.21 kg/m²), board R prepared using the same stucco, but with a different foaming agent), it is apparent that a number of large voids were present in the set gypsum core of Sample C1, which assisted in reducing the weight of the plasterboard, but without detrimentally altering strength performance characteristics.

### Example 5

Sample plasterboards D1 to D12 were prepared in accordance with the schematic flow sheet and schematic diagram for a plasterboard manufacturing process shown in FIGS. 1 and 2, using Formulation D, shown in Table 3 (i.e. the samples were manufactured in a plasterboard manufacturing plant). The stucco in Formulation D had been prepared by flash calcination, using an imp mill process where grinding and calcining of the gypsum occur in one step.

In each of Samples D1 to D12 the Foaming Agent was surfactant Composition D, shown in Table 4, and the samples were otherwise prepared as described in Example 3. The board weight and average nail pull resistance (AS/NZS 2588 minimum of 270 N) for Samples D1 to D12 are shown in Table 14.

TABLE 14

| | Board | Average Nail Pull |
|---|---|---|
| Sample | Weight (kg/m²) | Resistance (N) |
| D1 | 5.44 | 300 |
| D2 | 5.81 | 336 |
| D3 | 5.25 | 298 |
| D4 | 5.86 | 348 |
| D5 | 5.80 | 366 |
| D6 | 5.71 | 356 |
| D7 | 5.52 | 313 |
| D8 | 5.75 | 330 |
| D9 | 5.72 | 319 |
| D10 | 5.66 | 335 |
| D11 | 5.75 | 331 |
| D12 | 5.66 | 327 |

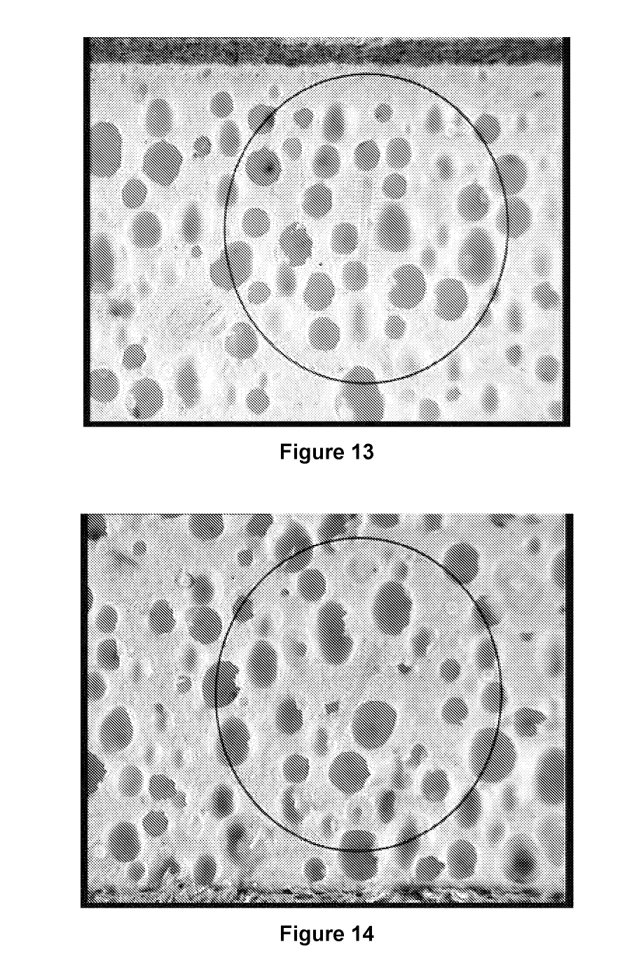

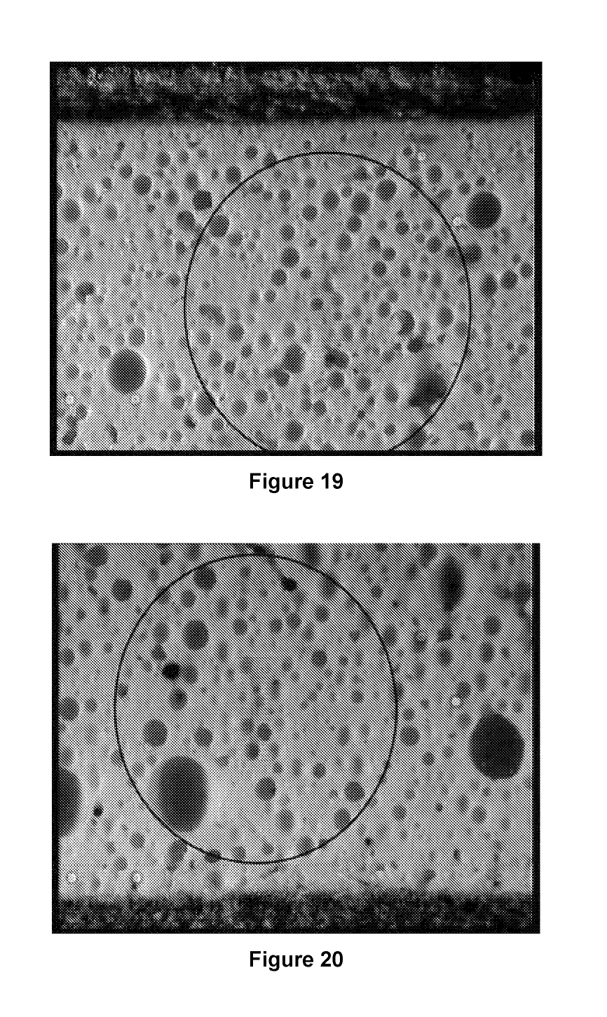

FIGS. 13 and 14 show, respectively, images of the front and back faces of the set gypsum core of Sample D11, a board having a weight of 5.75 kg/m². The denser layer of slurry that contained only a portion of foam can be clearly seen adjacent to the face paper in FIG. 13 for Sample D11. FIGS. 19 and 20 show a comparative, heavier (6.11 kg/m²), board S prepared using the same stucco, but with a different foaming agent. When compared with FIGS. 13 and 14, it is apparent that a number of large voids were present in the set gypsum core of Sample D11, which assisted in reducing the weight of the plasterboard, but without detrimentally altering strength performance characteristics.

### Example 6

Sample plasterboards E1 and E2 were prepared in accordance with the schematic flow sheet and schematic diagram for a plasterboard manufacturing process shown in FIGS. 1 and 2, using Formulation E as shown in Table 3 (i.e. the samples were manufactured in a plasterboard manufacturing plant). The stucco used in Formulation E was prepared by the continuous kettle calcination of ground gypsum, which is a slower process than the two different flash calcination methods identified in Examples 3 and 5.

Sample plasterboards E1 and E2 were prepared in a similar manner to that described in Example 3, including the use of surfactant Composition D as the Foaming Agent, with 220 gsm face paper sheet and 160 gsm back paper sheet. The boards were 10 mm thick, and the board weight of each was determined. Nail pull resistance and penetrometer were tested, with the results shown in Tables 15 and 16 respectively.

TABLE 15

| | Brd | Nail Pull Resistance | | | | | | | |
|---|---|---|---|---|---|---|---|---|---|
| | Wt | 1 | 2 | 3 | 4 | 5 | 6 | Avg | Avg |
| Sample | kg/m² | (kg) | (kg) | (kg) | (kg) | (kg) | (kg) | (kg) | (N) |
| E1 | 5.78 | 7.20 | 6.89 | 7.16 | 6.53 | 6.46 | 7.25 | 6.92 | 336.5 |
| E2 | 5.72 | 6.50 | 7.24 | 7.15 | 6.79 | 7.00 | 6.46 | 6.86 | 334.0 |

TABLE 16

| | Brd Wt | Penetrometer (N) | | | | | | |
|---|---|---|---|---|---|---|---|---|
| Sample | kg/m² | Top Edge | | | Bottom Edge | | | Avg |
| E1 | 5.78 | 87.0 | 92.3 | 91.8 | 77.6 | 84.7 | 85.6 | 86.5 |
| E2 | 5.72 | 80.0 | 96.9 | 81.5 | 61.2 | 59.3 | 56.3 | 72.5 |

Additional testing was conducted on Samples E1 and E2, in accordance with AS/NZ 2588. The results of bending strength in the machine direction (MD) and cross direction (XD) are shown in Tables 17 and 18 respectively, with the results of sag tests being shown in Table 19.

TABLE 17

| | Brd | Bending Strength (Machine Direction) | | | | | |
|---|---|---|---|---|---|---|---|
| | Wt | Face Down | | Back Down | | Avg | Avg |
| Sample | kg/m² | (kg) | | (kg) | | (kg) | (N) |
| E1 | 5.78 | 9.68 | 8.72 | 8.20 | 9.10 | 8.93 | 435.0 |
| E2 | 5.72 | 9.91 | 8.92 | 8.65 | 9.17 | 9.16 | 444.8 |

TABLE 18

| | Brd | Bending Strength (Cross Direction) | | | | | |
|---|---|---|---|---|---|---|---|
| | Wt | Face Down | | Back Down | | Avg | Avg |
| Sample | kg/m² | (kg) | | (kg) | | (kg) | (N) |
| E1 | 5.78 | 4.06 | 3.81 | 3.59 | 4.10 | 3.89 | 189.6 |
| E2 | 5.72 | 4.14 | 4.52 | 3.59 | 4.02 | 4.07 | 196.9 |

TABLE 19

| | Brd Wt | Sag | | |
|---|---|---|---|---|
| Sample | kg/m² | Initial | Final | Result |
| E1 | 5.78 | 7 | 20 | 13 |
| E2 | 5.72 | 9 | 25 | 16 |

The testing conducted on Samples E1 and E2 again show that plasterboards manufactured using the surfactant composition disclosed herein can be prepared that still meet various Australian and New Zealand Standards.

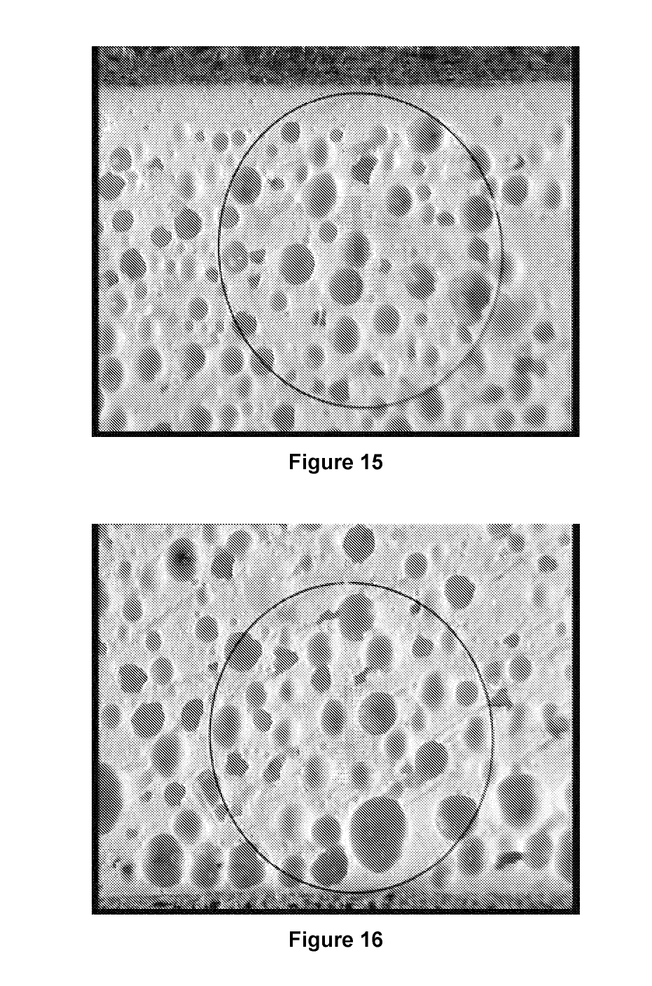

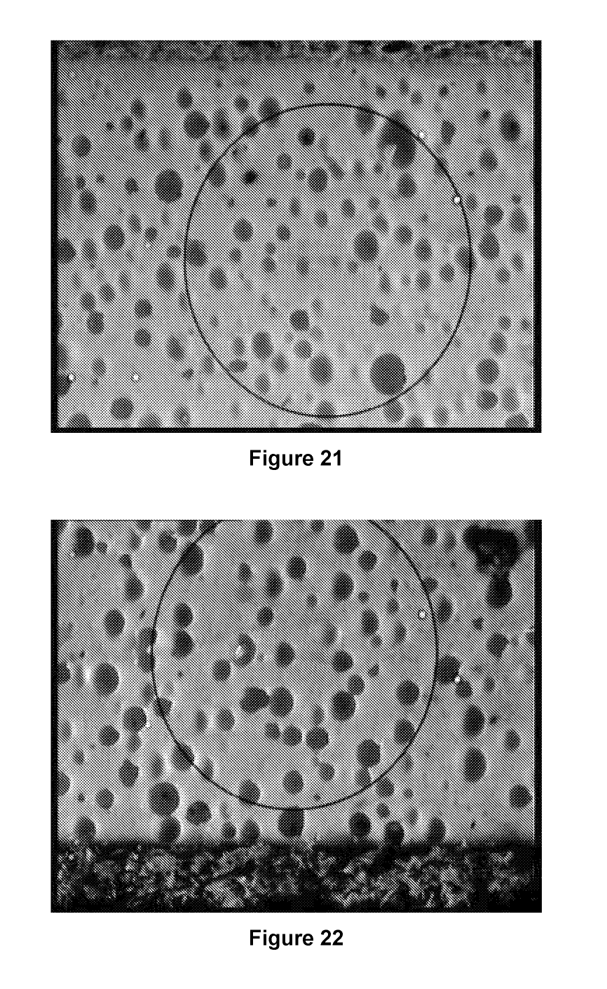

FIGS. 15 and 16 show, respectively, images of the front and back faces of the set gypsum core of Sample E1, a board having a weight of 5.78 kg/m². The denser layer of slurry that contained only a portion of foam can be clearly seen adjacent to the face paper in FIG. 15. FIGS. 21 and 22 show a comparative, heavier (6.20 kg/m²), board T prepared using the same stucco, but with a different foaming agent. When compared with FIGS. 15 and 16, it is apparent that a number of large voids were present in the set gypsum core of Sample E1, which assisted in reducing the weight of the plasterboard, but without detrimentally altering strength performance characteristics.

### Example 7

FIGS. 17 to 22 show, sequentially, representative images of the front and back face of the set gypsum core of three comparative plasterboards R, S and T. The three comparative boards R, S and T have a higher weight than the Sample boards shown in FIGS. 5 to 16. The three comparative boards R, S and T were prepared using facilities similar to those used to prepare the Sample plasterboards shown in FIGS. 5 to 16. As required, in a commercial context, the three comparative plasterboards R, S and T were manufactured to meet the Australian and New Zealand Standard (AS/NZS 2588) for gypsum plasterboard, with similar board weights (for example, manufactured to a target board weight of 6.2 kg/m², with manufacturing tolerances of about +/−0.2 kg/m²). Despite this, the core structures of comparative plasterboards R, S and T are quite different.

FIGS. 17 and 18 show, respectively, images of the front and back faces of a set gypsum core of a 6.21 kg/m² comparative plasterboard R, manufactured using stucco flash calcined by the Calcidyne™ process (similar to the calcination process employed to obtain the stucco used in the manufacture of the boards shown in FIGS. 5 to 12).

FIGS. 19 and 20 show, respectively, images of the front and back faces of a set gypsum core of a 6.11 kg/m² comparative plasterboard S manufactured using stucco flash calcined by an imp mill process (similar to the calcination process employed to obtain the stucco used in the manufacture of the board shown in FIGS. 13 and 14).

FIGS. 21 and 22 show, respectively, images of the front and back faces of a set gypsum core of a 6.20 kg/m² comparative plasterboard T manufactured using stucco prepared using continuous kettle calcination (similar to the calcination process employed to obtain the stucco used in the manufacture of the board shown in FIGS. 15 and 16).

In order to achieve commercially consistent plasterboard, two different foaming agents were required to be used to manufacture the comparative plasterboards R, S and T shown in FIGS. 17 to 22. Comparative plasterboards R and T were prepared using a blend of alkyl sulphate (having a carbon chain length of C10-C12) and alkyl ether sulphate (having a carbon chain length of C8 and C10, and a y-value of 2.2). Comparative plasterboard S, on the other hand, was prepared using only an alkyl ether sulphate (having a carbon chain length of C8 and C10, and a y-value of 0.8).

However, as demonstrated in Examples 3 to 6, the surfactant composition of the present disclosure was able to achieve commercially consistent plasterboard, manufactured in a plasterboard manufacturing plant, that met the Australian and New Zealand Standard (AS/NZS 2588) for gypsum plasterboard, despite the different gypsum calcining methods. The surfactant composition of the present disclosure was also able to produce commercially consistent plasterboard for various controlled ranges of the alkyl sulphate component and the alkyl ether sulphate component.

Whilst a number of specific surfactant composition and gypsum plasterboard embodiments have been described, it should be appreciated that they may be embodied in many other forms. For example, modifications may be made to the slurry formulation to achieve even lighter weight gypsum plasterboards that still maintain acceptable strength characteristics.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the composition, method and gypsum product as disclosed herein.

1. A surfactant composition comprising:
from 60 to 99 wt. % by total surfactant weight of an alkyl sulphate component having the structure:
R¹—OSO₃⁻⁺M¹
in which R¹ is an alkyl having from 9 to 11 carbon atoms and M¹ is a cation; and
from 1 to 40 wt. % by total surfactant weight of an alkyl ether sulphate component having the structure:
R²—(OCH₂CH₂)_{y}OSO₃⁻⁺M²
in which R² is an alkyl having from 8 to 10 carbon atoms, y has an average value of 0.1 to 5 and M² is a cation;
wherein the alkyl sulphate component comprises a mixture of:
alkyl sulphate where R¹ is an alkyl having 9 carbon atoms;
alkyl sulphate where R¹ is an alkyl having 10 carbon atoms; and
alkyl sulphate where R¹ is an alkyl having 11 carbon atoms.

2. The composition as claimed in claim 1 wherein the alkyl sulphate component comprises from 70 to 95 wt. % and the alkyl ether sulphate comprises from 5 to 30 wt. % by total surfactant weight.

3. The composition as claimed in claim 1 wherein the alkyl sulphate component comprises from 75 to 90 wt. % and the alkyl ether sulphate comprises from 10 to 25 wt. % by total surfactant weight.

4. The composition as claimed in claim 1 wherein the alkyl sulphate component comprises approximately 80 wt. % and the alkyl ether sulphate comprises approximately 20 wt. % by total surfactant weight.

5. The composition as claimed in claim 1 wherein the alkyl ether sulphate component comprises a mixture of:
alkyl ether sulphate where R² is an alkyl having 8 carbon atoms; and
alkyl ether sulphate where R² is an alkyl having 10 carbon atoms.

6. The composition as claimed in claim 5 wherein the alkyl ether sulphate component comprises a mixture of:
approximately 45 wt. % alkyl ether sulphate where R² is an alkyl having 8 carbon atoms; and
approximately 55 wt. % alkyl ether sulphate where R² is an alkyl having 10 carbon atoms.

7. (canceled)

8. The composition as claimed in claim 1, wherein the alkyl sulphate component comprises a mixture of:
approximately 18% alkyl sulphate where R¹ is an alkyl having 9 carbon atoms;
approximately 42% alkyl sulphate where R¹ is an alkyl having 10 carbon atoms; and
approximately 38% alkyl sulphate where R¹ is an alkyl having 11 carbon atoms;
the balance being alkyl sulphates where R¹ is an alkyl having 8 carbon atoms or less and 12 carbon atoms or more.

9. The composition as claimed in claim 1 wherein M¹ and M² are selected from the group consisting of: sodium, ammonium, calcium, potassium, magnesium, quaternary ammonium, or a combination thereof.

10. The composition as claimed in claim 1, wherein M¹ and M² are independently selected.

11. The composition as claimed in claim 1, wherein R¹ is branched, linear or a combination thereof.

12. The composition as claimed in claim 1, wherein R² is branched, linear or a combination thereof.

13. The composition as claimed in claim 1, wherein the alkyl sulphate component and the alkyl ether sulphate component are combined.

14. (canceled)

15. A method of producing a gypsum plasterboard, the method comprising the steps of:
a. mixing at least water and stucco to form a slurry;
b. adding foam to the slurry to form a foamed slurry;
c. depositing the foamed slurry onto a first cover sheet;
d. positioning a second cover sheet on the foamed slurry to form a gypsum panel;
e. allowing the gypsum panel to set;
f. cutting the gypsum panel into a plasterboard of predetermined dimensions; and
g. drying the plasterboard,
wherein the foam is generated from a foaming agent comprising the surfactant composition as claimed in claim 1.

16. The method as claimed in claim 15 wherein the foaming agent is added into a water line to form a foam water concentrate.

17. The method as claimed in claim 16 wherein the foam water concentrate and air are added into a foam generator to form the foam.

18. The method as claimed in claim 15 wherein, at step b, initially a portion of the foam is added to the slurry to form an intermediary slurry, before the remaining foam is added to the intermediary slurry to form the foamed slurry.

19. The method as claimed in claim 18 wherein a portion of the intermediary slurry is removed and deposited onto the first cover sheet to form a thin dense layer, prior to step c.

20. The method as claimed in claim 15 wherein the slurry further comprises additives including accelerators, retarders, water reducing agents, board stiffening agents, binding agents, fibre reinforcements or waterproofing agents.

21. A gypsum plasterboard comprising:
a first cover sheet;
a foamed set gypsum core; and
a second cover sheet
wherein the foamed set gypsum core is formed from a slurry, comprising stucco and water, to which foam is added to form a foamed slurry, wherein the foam is generated from a foaming agent comprising the surfactant composition as claimed in claim 1.

22. A gypsum plasterboard as claimed in claim 21 further comprising a thin, denser bonding layer between the first cover sheet and the foamed set gypsum core, wherein the thin, denser bonding layer is set gypsum formed from the slurry, to which only a portion of the foam had been added.
